(19) United States
(12) Patent Application Publication
(10) Pub. No.: US 2007/0115569 A1
(43) Pub. Date: May 24, 2007

(54) Brightness enhancement film having curved prism units and microstructure layer

(75) Inventors: Shih-Chieh Tang, Tainan (TW); Ying-Tsung Lu, Kaohsiung (TW); Kai-Cheng Chang, Tainan (TW); Ching-Chin Wu, Tainan (TW)

Correspondence Address: BACON & THOMAS, PLLC, 625 SLATERS LANE, FOURTH FLOOR, ALEXANDRIA, VA, 22314, US

(73) Assignee: EFUN TECHNOLOGY CO., LTD., Tainan (TW)

(21) Appl. No.: 11/653,947

(22) Filed: Jan. 17, 2007

Related U.S. Application Data
(63) Continuation-in-part of application No. 10/882,346, filed on Jul. 2, 2004.

(30) Foreign Application Priority Data
Oct. 19, 2006 (TW) 95138642

(51) Int. Cl. G02B 5/04

(52) U.S. Cl. 359/831

(57) ABSTRACT

A brightness enhancement film includes a substrate, a plurality of curved prism units and a light-diffusing microstructure layer. The curved prism units are extended in parallel and formed on a first surface of the substrate. Each of the curved prism units includes at least one meandering surface to provide with changes in curvature. Thus, the meandering surface of the curved prism unit is able to refract incident light in two dimensions with respect to the substrate that may enhance entire light-collecting efficiency in two dimensions. The light-diffusing microstructure layer is formed on a second surface of the substrate.

### CROSS REFERENCE TO RELATED APPLICATION

This application is a continuation-in-part application of U.S. Pat. Ser. No. 10/882,346, filed on Jul. 2, 2004.

### BACKGROUND OF THE INVENTION

1. Field of the Invention

The present invention relates to a brightness enhancement film having curved prism units and a light-diffusing microstructure layer. Particularly, the present invention relates to a brightness enhancement film having curved prism units and a light-diffusing microstructure layer arranged on opposite surfaces. More particularly, the present invention relates to a brightness enhancement film having curved prism units each of which is extended in a meandering line to provide changes in curvature. The brightness enhancement film is applied to a Liquid Crystal Display that improves the entire optical refractive characteristic.

2. Description of the Related Art

Referring to FIGS. 1 and 2, International Patent Publication No. WO 96/23649 discloses a brightness enhancement film 9 including a base layer 91 and a plurality of prisms 92 juxtaposed in order on a first surface of the base layer 91. Each of the prisms 92 consists of a first flat facet and a second flat facet adapted to refract lights to produce a condense light.

However, the first flat facet and the second flat facet of the prisms 92 are flat surfaces to refract lights in one dimension with respect to the first surface (i.e. emitting surface) of the brightness enhancement film 9. The first flat facet and the second flat facet refract a light beam 93 which is transmitted from a second surface (i.e. incident surface) of the base layer 91. The light beam 93 may have an angle of incidence with respect to a longitudinal direction of the second surface of the base layer 91 while the light beam 93 penetrates through the first flat facet and the second flat facet of the prisms 92. On the second surface of the base layer 91, the incident angle of the light beam 94 may be smaller than a value in the range of 6 degrees to 9 degrees. In light emitting, the relatively small angle of incidence of the light beam 94 may generate total internal reflection on the first flat facet and the second flat facet of the prisms 92. Disadvantageously, the light beam 94 cannot penetrate through the prisms 92. Consequently, this results in poor transmission efficiency of emitted lights of the brightness enhancement film 9.

In addition to this, when the two brightness enhancement films 9 are assembled together in a stacked relationship, there exists some gaps between the two brightness enhancement films 9 due to mists or dusts entering between two adjacent surfaces of the two brightness enhancement films 9 or uneven surfaces of the brightness enhancement films 9. With regard to the problematic aspects naturally occurring during use of the brightness enhancement film 9, the assembled brightness enhancement films are susceptible to a number of problems, including: (1) the film's adhesion causing a wet-out phenomenon; and (2) the gap causing several Newton's rings. Disadvantageously, the wet-out phenomenon or Newton's rings will result in poor images of the LCDs.

Another brightness enhancement film is also disclosed in U.S. Pat. No. 5,600,462, which is titled “OPTICAL FILM AND LIQUID CRYSTAL DISPLAY DEVICE USING THE SAME.” This brightness enhancement film herein known as an optical film includes a wave structure and an optically rough structure. The film has a first surface having the wave structure, and a second surface having the optically rough structure. The wave structure includes a plurality of isosceles triangle prisms arranged side-by-side for refracting lights transmitted from the second surface. The optically rough structure can perform diffuse transmission for lights in use. Also, the wave structure refracts the diffused lights transmitted from the optically rough structure.

Another brightness enhancement film is also disclosed in U.S. Pat. No. 5,841,572, which is titled “LENS ARRAY SHEET, SURFACE LIGHT SOURCE, AND TRANSMISSION TYPE DISPLAY DEVICE.” This brightness enhancement film herein known as a lens array sheet includes a transparent substrate, a lens array and a cluster. The lens array includes lens elements one-dimensionally or two-dimensionally formed on a front surface of the transparent substrate. The cluster includes a number of cluster members randomly formed in a prism shape on a rear surface of the transparent substrate.

Another brightness enhancement film is also disclosed in U.S. Pat. No. 6,280,063, which is titled “BRIGHTNESS ENHANCEMENT ARTICLE.” This brightness enhancement film herein known as a brightness enhancement article includes a transparent, flexible substrate, an array of prisms with blunted or rounded peaks, and a plurality of light scattering protrusions. The prisms are formed on a first major surface of the substrate while the light scattering protrusions are formed on a second major surface of the substrate. In use, the light scattering protrusions diffuse lights which penetrate the second major surface of the substrate. Also, on the first major surface of the substrate, the prisms condense the diffused lights transmitted from the light scattering protrusions.

Another brightness enhancement film is also disclosed in U.S. Pat. No. 6,322,236, which is titled “OPTICAL FILM WITH DEFECT-REDUCING SURFACE AND METHOD FOR MAKING THE SAME.” This brightness enhancement film herein known as an optical film includes a substrate and wet-out reducing means arranged on a first surface of the substrate. The first wet-out reducing means can reduce such defects as wet-out, Newton's rings and Moire effects. The first surface of the substrate is free of regular structure or is an anti-wet-out surface having no regularly refractive structure.

Another brightness enhancement film is also disclosed in U.S. Pat. No. 6,356,389, which is titled “SUBWAVELENGTH OPTICAL MICROSTRUCTURE LIGHT COLLIMATING FILMS.” This brightness enhancement film herein known as a light collimating film includes a sheeting, a series of prisms and a plurality of subwavelength optical microstructures (i.e. moth-eye structure). The prisms are formed on a first side of the sheeting. The subwavelength optical microstructures are formed on a second side of the sheeting. The prisms arranged on the first side of the sheeting refract light for generating condensed light. Also, the subwavelength optical microstructures can increase the transmittance of lights while passing through the second side of the sheeting.

Another brightness enhancement film is also disclosed in U.S. Pat. No. 6,880,946, which is titled “GROOVED OPTICAL MICROSTRUCTURE LIGHT COLLIMATING FILMS.” This brightness enhancement film herein known as a light collimating film includes a sheet, a series of optical elements, a series of stepped plateaus and a series of base planes. The optical elements are arranged on a first surface of the sheet. The stepped plateaus and the base planes are alternatively spaced on a second surface of the sheet for diffusing light. Also, the optical elements can refract diffused light transmitted from the second surface of the sheet.

The present invention intends to provide a brightness enhancement film having curved prism units and a light-diffusing microstructure layer arranged on opposite surfaces. Each of the curved prism units extends in a meandering line so that at least one surface of the curved prism unit provides changes in curvature, i.e., such that a direction of the meandering surface relative to the longitudinal direction varies along a length of each of the prism units. Thereby, the changes of the curved prism unit in curvature refract light in two dimensions to attenuate the moire phenomenon and the structure of the curved prism units are simplified in such a way as to mitigate and overcome the above problem. Furthermore, the light-diffusing microstructure layer can reduce wet-out, Newton's rings, and Moire effects.

### SUMMARY OF THE INVENTION

The primary objective of this invention is to provide a brightness enhancement film having curved prism units and a light-diffusing microstructure layer. Each of the prism units includes at least one surface extending in a meandering line so as to provide changes in curvature to refract light in two dimensions. Thereby, the curved prism units extending in a meandering line enhances the entire light-collecting efficiency in two dimensions, and the microstructure layer also enhances an anti-wet-out effect.

The secondary objective of this invention is to provide a brightness enhancement film having curved prism units, which are arranged to longitudinally extend in haphazard order so as to attenuate the moire phenomenon. The light-diffusing microstructure layer can reduce Newton's rings of the brightness enhancement film.

Another objective of this invention is to provide a brightness enhancement film having curved prism units and a light-diffusing microstructure layer, wherein the light-diffusing microstructure layer is made of a relatively rigid material to enhance a degree of wear resistance and to reinforce the entire structure.

Another objective of this invention is to provide a brightness enhancement film having curved prism units and a light-diffusing microstructure layer, wherein the light-diffusing microstructure layer can increase a degree of directly emitting light on the curved prism units, and can reduce the occurrence of total internal reflection of light on the curved prism units.

The brightness enhancement film in accordance with an aspect of the present invention comprises a substrate, a plurality of curved prism units and a light-diffusing microstructure layer. The curved prism units are extended in parallel and formed on a first surface of the substrate. Each of the curved prism units includes at least one meandering surface to provide with changes in curvature. Thus, the meandering surface of the curved prism unit is able to refract incident light in two dimensions with respect to the substrate that may enhance entire refractive efficiency in two dimensions. The light-diffusing microstructure layer is formed on a second surface of the substrate.

The substrate and the curved prism units of the brightness enhancement film in accordance with the present invention form a single film, and are made of identical transparent material. Alternatively, the substrate and the curved prism units are made of dissimilar transparent material, and adhered to each other. Thereby, the brightness enhancement film may widen the scope of application and manufacture.

In a separate aspect of the present invention, the curved prism unit includes a plurality of lateral ridges arranged on the meandering surface.

In a further separate aspect of the present invention, the brightness enhancement film includes a plurality of light scattering particles embedded in the curved prism units.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a perspective view of a brightness enhancement film of International Patent Publication No. WO96/ 23649 in accordance with the prior art;

FIG. 2 is an enlarged, side elevational view of the brightness enhancement film in accordance with the prior art, depicted in FIG. 1;

FIG. 3 is a top perspective view of a brightness enhancement film having curved prism units and a microstructure layer in accordance with a first embodiment of the present invention;

FIG. 4 is a bottom perspective view of the brightness enhancement film having curved prism units and a microstructure layer in accordance with the first embodiment of the present invention, depicted in FIG. 3;

FIG. 5 is an enlarged perspective view of the brightness enhancement film having curved prism units and a microstructure layer in accordance with the first embodiment of the present invention, depicted in FIG. 3;

FIG. 5A is an enlarged perspective view, similar to FIG. 5, of the brightness enhancement film having curved prism units and a microstructure layer in accordance with a second embodiment of the present invention;

FIG. 6 is an enlarged, side elevational view of the brightness enhancement film in accordance with the first and second embodiments of the present invention;

FIG. 7 is a top perspective view of the brightness enhancement film having curved prism units and a microstructure layer in accordance with a third embodiment of the present invention;

FIG. 8 is an electronic microscopic image of the curved prism units of the brightness enhancement film in accordance with the preferred embodiment of the present invention; and

FIG. 9 is an electronic microscopic image of the microstructure layer of the brightness enhancement film in accordance with the preferred embodiment of the present invention.

### DETAILED DESCRIPTION OF THE INVENTION

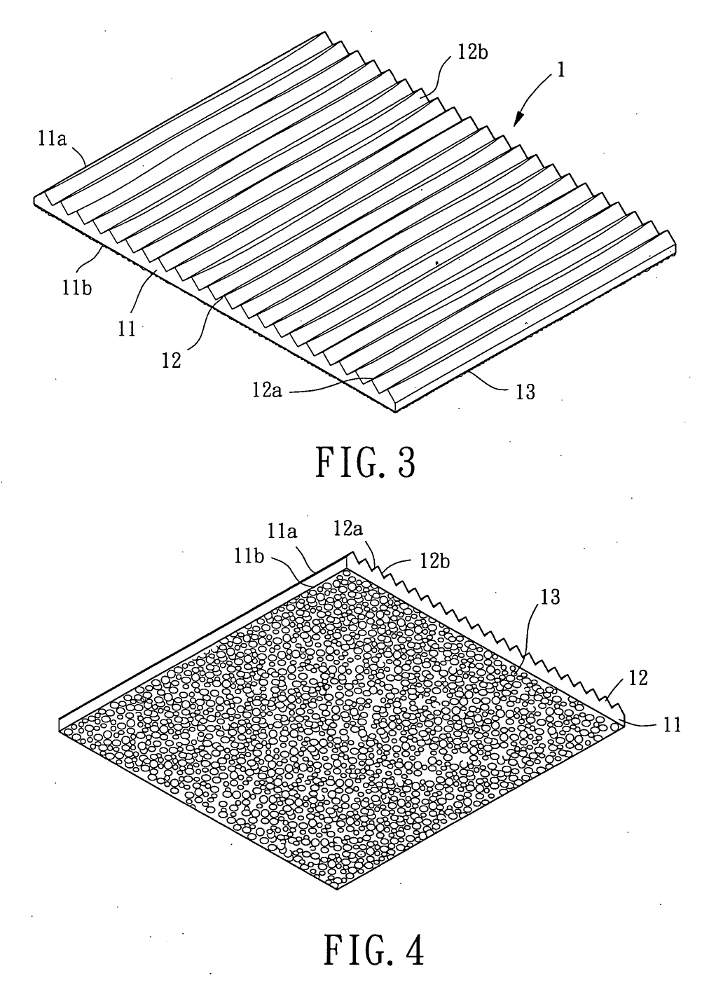

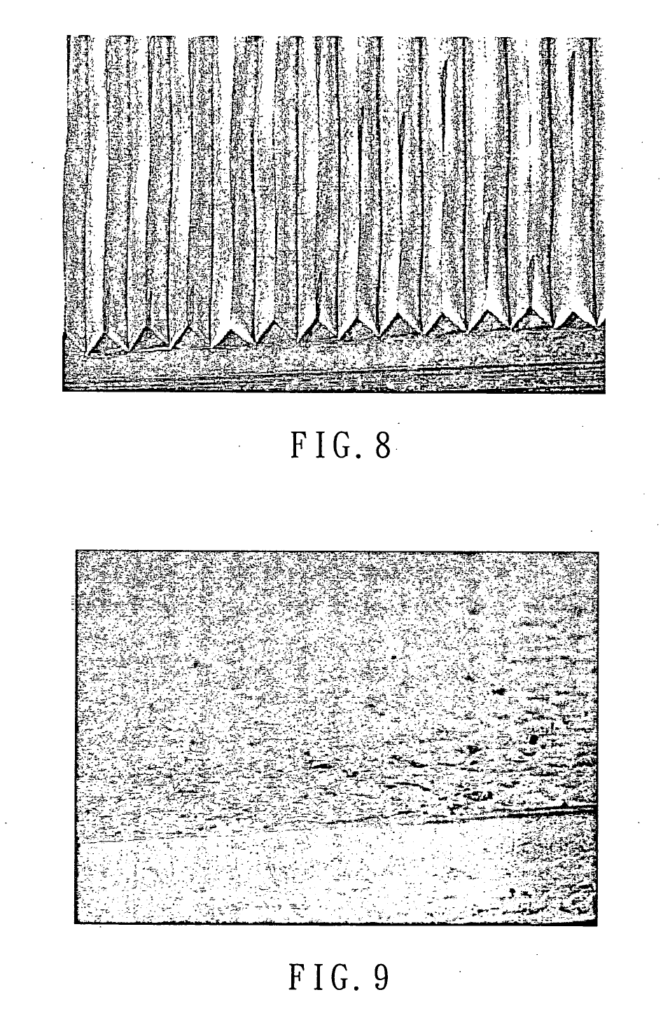

Referring initially to FIGS. 3 through 5, 8 and 9, a brightness enhancement film 1 in accordance with a first embodiment of the present invention includes a substrate 11 and a plurality of curved prism units 12 which are made of transparent materials to thereby constitute a single film. The brightness enhancement film 1 further includes a light-diffusing microstructure layer 13. The substrate 11 includes a first surface 11a and a second surface 11b substantially parallel thereto and thus light is able to penetrate the substrate 1 therebetween. The first surface 11a and the second surface 11b can be regarded as a light-emitting side (i.e. light-exiting side) and a light incident side, and vice versa. The curved prism units 12 constitute a microstructure layer, and are selectively juxtaposed on the first surface 11a of the substrate 11. Structurally, each of the curved prism units 12 essentially consists of a first meandering surface 12a and a second meandering surface 12b. The first meandering surface 12a and the second meandering surface 12b of the curved prism unit 12 define a common ridge. Alternatively, the first meandering surface 12a of the curved prism unit 12 and the second meandering surface 12b of the adjacent curved prism unit 12 define a common trough line which is regarded as a common boundary of any two adjacent units of the curved prism units 12.

With continued reference to FIGS. 3 through 5 and 8, each route of the curved prism units 12 is longitudinally extended along a meandering line with respect to the substrate 11, and the curved prism units 12 are juxtaposed on the first surface 11a of the substrate 11. With respect to the first surface 11a of the substrate 11, the curved prism units 12 have various vertical heights (H) and various horizontal widths (W). The first meandering surface 12a and the second meandering surface 12b of the curved prism unit 12 are longitudinally extended in a meandering line in order to provide changes in curvature even though the routes of the curved prism units may be essentially parallel. In use, incident light transmitted from the second surface 11b of the substrate 11 is appropriately directed to the curved prism units 12, and thus the curvature of the first meandering surface 12a and the second meandering surface 12b may refract it in two dimensions. Thereby, the curvature of the first meandering surface 12a and the second meandering surface 12b may relatively enhance the entire light-collecting efficiency of the brightness enhancement film in two dimensions.

In a preferred embodiment, an included angle formed between the first meandering surface 12a and the second meandering surface 12b located at the ridge of the curved prism unit 12 is in the range of 70 degrees to 160 degrees, more preferably in the range of 85 degrees to 95 degrees. In another preferred embodiment, the vertical height (H) of the curved prism unit 12 is in the range of 10 μm to 100 μm, more preferably in the range of 20 μm to 75 μm. Alternatively, the vertical heights (H) of the curved prism units 12 are all the same. In another preferred embodiment, the horizontal width (W) of the curved prism unit 12 is in the range of 10 μm to 250 μm, more preferably in the range of 25 μm to 80 μm. In another preferred embodiment, the ridge or the trough line of the curved prism unit 12 meanders in length and the trough line deviates from a center reference line within ±5 μm. Preferably, each of the first meandering surface 12a and the second meandering surface 12b has regular changes in curvature or free of regular changes in curvature.

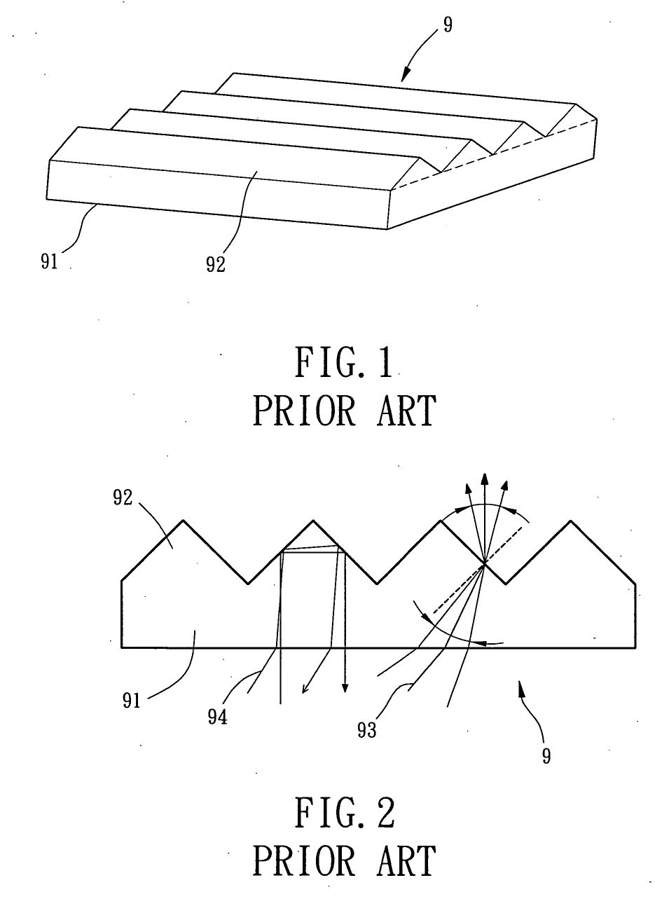

Referring again to FIGS. 3 through 5, the meandering route of the curved prism unit 12 can relatively attenuate the moire phenomenon, thereby increasing the quality of optical display of the brightness enhancement film. In comparison with the brightness units 92 of the conventional film as shown in FIGS. 1 and 2, the structure of the curved prism units 12 of the present invention is simplified and thus manufacture cost of the mold assembly is reduced.

With continued reference to FIGS. 3 through 5, the substrate 11 and the curved prism units 12 are made of similar flexible, transparent material and are integrally formed. In an alternative embodiment, the substrate 11 and the curved prism units 12 are made of dissimilar materials. In manufacturing, the substrate 11 and the curved prism units 12 are preferably combined by means of adhesion or other suitable means. The curved prism units 12 are formed on the substrate 11 by die assemblies, press rolling machines, mold pressing assemblies or other equivalent apparatuses. The flexible, transparent material of the substrate 11 is preferably selected from the group consisting of polyethylene-terephthalate (PET), polyethylene (PE), polyethylene napthalate (PEN), polycarbonate (PC), polyvinyl alcohol (PVA), polyvinyl chloride (PVC), macromolecule and mixtures thereof. In a preferred embodiment, the transparent material of the curved prism units 12 are made from UV adhesive, such as UV curable adhesive.

Referring again to FIGS. 3 through 5 and 9, the light-diffusing microstructure layer 13 includes microstructure protrusions randomly formed thereon. The light-diffusing microstructure layer 13 is made from a transparent material selected from UV adhesive or acrylic resin. In particular, the transparent material of the light-diffusing microstructure layer 13 has hardness greater than that of the substrate 11 so as to reinforce the entire structure of the brightness enhancement film 1. Also, the transparent material of the light-diffusing inicrostructure layer 13 is selected from a relatively rigid material so as to enhance a degree of wear resisting ability of the brightness enhancement film 1. Preferably, the transparent material of the light-diffusing microstructure layer 13 has the same contractibility with the substrate 11 of the brightness enhancement film 1 such that the light-diffusing microstructure layer 13 can attenuate warpage of the brightness enhancement film 1 in use. In the first embodiment, the light-diffusing microstructure layer 13 has a thickness in the range of 5 μm to 200 μm. The light-diffusing microstructure layer 13 includes a plurality of microstructure protrusions 131 formed on its surface. Such a microstructure protrusion 131 can preferably be in a range of sizes from 0.2 μm to 100 μm, more preferably in a range of sizes from 1.0 μm to 25 μm. Preferably, the microstructure protrusions 131 can be in the form of spherical cambered protrusions, oval shaped protrusions, olive shaped protrusions, ovum shaped protrusions, cross shaped protrusions, raster shaped protrusions, prism shaped protrusions, curved prism shaped protrusions and irregular faceted protrusions. In particular, the microstructure protrusions 131 vary in heights with respect to the second surface 11b of the substrate 11, and various heights thereof are randomly arranged on the light-diffusing microstructure layer 13.

The light-diffusing microstructure layer 13 can be integrally or separately formed on the second surface 11b of the substrate 11 by means of press rolling, coating and adhesive etc. Preferably, the light-diffusing microstructure layer 13 is provided on the light incident side to cover the second surface 11b of the substrate 11. The manufacturing method for the light-diffusing microstructure layer 13 of the brightness enhancement film 1 in accordance with the present invention is further described in the following examples and the methods described herein are not by way of limitation.

### EXAMPLE 1

Firstly, a press roller (not shown) and particles (not shown) are prepared. Preferably, the particles are in a range of sizes from 0.2 μm to 100 μm. A jet of the particles sprayed from a spray nozzle is applied to form a surface relief microstructure provided on the press roller which is used to manufacture the light-diffusing microstructure layer 13 of the brightness enhancement film 1. The density of the surface relief microstructure formed on the press roller can be controlled by the jetting speed of the particles, the form of the spray nozzle or the speed of the spray nozzle. The surface relief microstructure of the press roller is in the form of randomly arranged microstructure.

Secondly, the UV adhesive is utilized to coat the first surface 11a of the substrate 11, and a series of the curved prism units 12 are formed thereon. Subsequently, the UV adhesive is further utilized to coat the second surface 11b of the substrate 11, and the surface relief microstructure of the press roller can form a pattern of the light-diffusing microstructure layer 13. Once cured, the microstructure protrusions 131 of the light-diffusing microstructure layer 13 are formed on the second surface 11b of the substrate 11, as best shown in FIG. 9. Depending on the pattern of the surface relief microstructure of the press roller, the microstructure protrusions 131 can be in the form of spherical cambered protrusions, oval shaped protrusions, olive shaped protrusions, ovum shaped protrusions or irregular faceted protrusions.

### EXAMPLE 2

The manufacturing method applied above or other equivalent methods can be also used to form the light-diffusing microstructure layer 13 of the brightness enhancement film 1 on the second surface 11b of the substrate 11. Depending on the pattern of the surface relief microstructure of the press roller, the microstructure protrusions 131 can be in the form of cross shaped protrusions, raster shaped protrusions or mixtures thereof. Preferably, the microstructure protrusions 131 are in the size of sub-micronmeter. The microstructure protrusions 131 are selected from similar patterns having the substantially same height. Various microstructure protrusions 131 are randomly distributed, spun or regularly arranged. The microstructure protrusion 131 has a minimum height greater than a half of wavelength of light but a maximum height less than 500 μm. Furthermore, the light-diffusing microstructure layer 13 may include at least two sets of the microstructure protrusions 131 with different heights. One is a major repeatedly microstructure unit while the other is a normal repeatedly microstructure unit. The microstructure protrusions 131 of the major repeatedly microstructure unit have a greater size and a higher height than of those of the normal repeatedly microstructure unit.

### EXAMPLE 3

The manufacturing method applied above or other equivalent methods can be used to form the curved prism units 12 on the first surface 11a of the substrate 11. Subsequently, formed on the second surface 11b of the substrate 11 is the light-diffusing microstructure layer 13 of the brightness enhancement film 1. Depending on the pattern of the surface relief microstructure of the press roller, the microstructure protrusions 131 can be in the form of prism shaped protrusions, curved prism shaped protrusions or mixtures thereof. Preferably, the prism shaped protrusions or the curved prism shaped protrusions extend in length of the curved prism units 12.

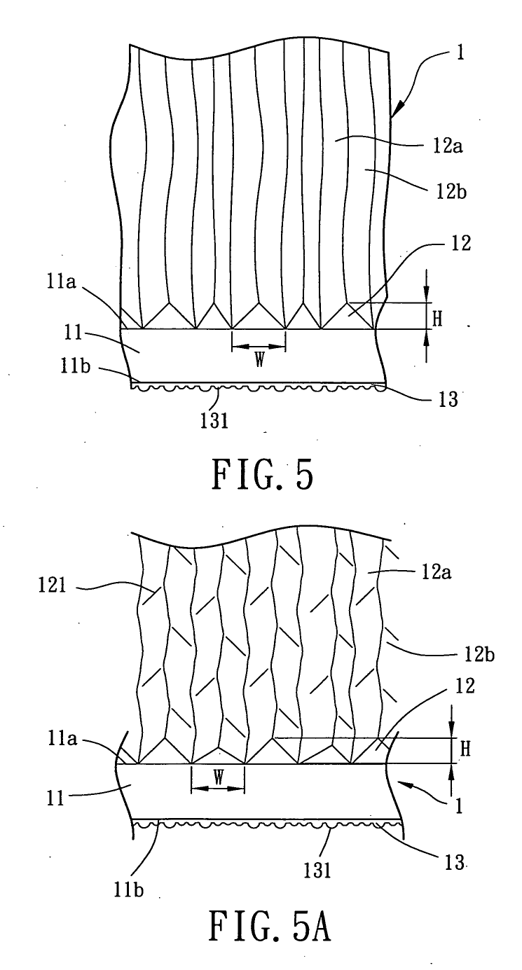

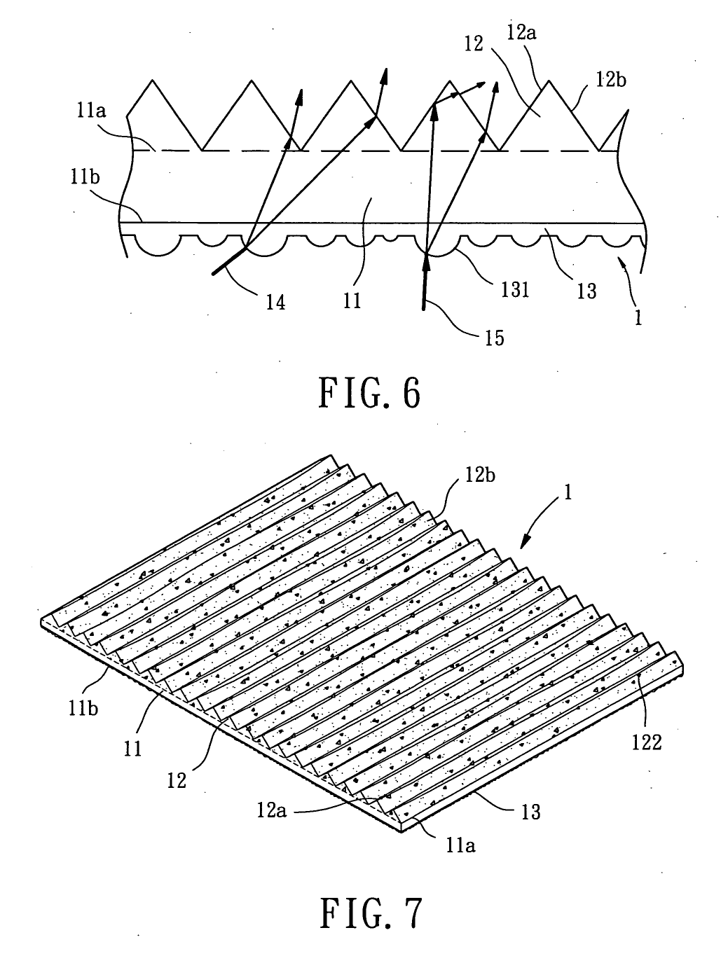

Referring back to FIGS. 5 and 6, the second surface 11b of the substrate 11 is provided with the light-diffusing microstructure layer 13 as well as a light-refracting layer in which the microstructure protrusions 131 are randomly distributed for refracting incident light beams 14, 15. The microstructure of the light-diffusing microstructure layer 13 can diffuse the incident light beams 14, 15 with various angles, as indicated by the direction arrows in FIG. 6. In a preferred embodiment, the first meandering surface 12a of the curved prism unit 12 provides variations in curvature similar or dissimilar to those of the second meandering surface 12b. Subsequently, the first meandering surface 12a and the second meandering surface 12b of the curved prism units 12 can provide various surface curvatures, and further refract the incident lights in two dimensions on the first surface 11a of the substrate 11.

Still referring to FIG. 6, the light beam 14 passes through the light-diffusing microstructure layer 13 of the brightness enhancement film 1 with a greater angle of incidence with respect to a vertical direction of the second surface 11b of the substrate 11 while the light beam 15 passes through the light-diffusing microstructure layer 13 of the brightness enhancement film 1 with a smaller angle of incidence, such as an angle of 6 degrees to 9 degrees. Both of the two light beams 14 and 15 can be sufficiently diffused on the microstructure protrusions 131 of the light-diffusing microstructure layer 13 regardless of the greater or smaller angle of incidence. Thus the direction of incident light is adjusted. A number of diffused lights are more likely uniform and further transmitted to the curved prism units 12 of the brightness enhancement film 1. In addition, the light-diffusing microstructure layer 13 of the brightness enhancement film 1 is closely in contact with another brightness enhancement film (or other optical film) to randomize the contact portions formed therebetween such that the light-diffusing microstructure layer 13 can enhance the anti-wet-out effect and the Newton's rings of the brightness enhancement film 1.

Moreover, the light-diffusing microstructure layer 13 of the brightness enhancement film 1 can eliminate the total internal reflection of emitting light on the first meandering surface 12a and the second meandering surface 12b of the curved prism unit 12. Accordingly, the light-diffusing microstructure layer 13 of the brightness enhancement film 1 accomplishes a preferred transmittance of the curved prism unit 12.

In comparison with the conventional brightness enhancement film 9 as shown in FIG. 1, the light-diffusing microstructure layer 13 of the brightness enhancement film 1 of the present invention can modify the surface quality of the light-emitting side, and can reduce such defects as spots, scratches and stains. The light-diffusing microstructure layer 13 can also provide a higher degree of hardness to reinforce the entire structure of the brightness enhancement film 1 in use. Advantageously, the material of the light-diffusing microstructure layer 13 is relatively rigid and strong to avoid abrasion on assembling lines or shipping. Also, the light-diffusing microstructure layer 13 can reduce such defects as wet-out, Newton's rings and Moire effects of the conventional brightness enhancement film 9.

Turning now to FIG. 5A, reference numerals of the second embodiment of the present invention have applied the identical numerals of the first embodiment. The construction of the brightness enhancement film in accordance with the second embodiment of the present invention has similar configuration and same function as that of the first embodiment and detailed descriptions may be omitted.

In comparison with the first embodiment, the first meandering surface 12a and the second meandering surface 12b of the curved prism unit 12 of the second embodiment include a plurality of lateral ridges 121 arranged in staggered manner in a longitudinal direction. Each of the lateral ridges 121 connects between the common ridge and the common trough line so that the curved prism units 12 are longitudinally extended in a meandering line to provide with great changes in curvature on the lateral ridges 121. Furthermore, each of the lateral ridges 121 can be selectively has the same uniform curvature or various curvatures.

Turning now to FIG. 7, reference numerals of the third embodiment of the present invention have applied the identical numerals of the first embodiment. The construction of the brightness enhancement film in accordance with the third embodiment of the present invention has similar configuration and same function as that of the first embodiment and detailed descriptions may be omitted.

In comparison with the first embodiment, the curved prism units 12 of the third embodiment contain a predetermined amount of light scattering particles 122 whose weight percentage is in the range of about 1 wt% to about 35 wt%. The light scattering particles 122 are preferably made from a material different from that of the curved prism units 12, selecting from plastic or glass for example. Preferably, the material of the light scattering particles 122 is selected from the group consisting of SiO₂, Al₂O₃, B₂O₃, CaO, MgO, silicon resin, polyester resin, styrene resin and mixtures thereof. In a preferred embodiment, the curved prism units 12 contain a predetermined amount of the light scattering particles 122 which occupies in the range of weight percentage from 1 to 35 within the total material of 100 weight percentage. In another preferred embodiment, the light scattering particles 122 are in a range of sizes from 0.5 μm to 30 μm, more preferably in a range of sizes from 0.5 μm to 10 μm. In another preferred embodiment, the light scattering particles 122 can be in the form of sphere, roughly shaped sphere, olive, ovum and irregular faceted particle.

It is apparent from FIG. 6 that lights pass through the microstructure protrusions 131 of the light-diffusing microstructure layer 13 on the second surface 11b of the substrate 11 (i.e. light incident side), and the microstructure protrusions 131 can scatter the incident light to generate a diffused light. Furthermore, the first meandering surface 12a and the second meandering surface 12b of the curved prism unit 12 can refract the diffused light transmitted from the light-diffusing microstructure layer 13. In particular, the light scattering particles 122 embedded in the curved prism units 12 can provide a higher degree of refraction for light so as to enhance the brightness of the brightness enhancement film 1. Advantageously, the light scattering particles 122 can diffuse the emitting light on the curved prism units 12, and can reduce the occurrence of total internal reflection of light on the curved prism units 12.

As has been discussed above, the conventional brightness enhancement film 9 is absent a light-diffusing microstructure layer of the present invention provided on its light incident side, by referring back to FIGS. 1 and 2. Also, the conventional brightness enhancement film 9 is absent light scattering particles embedded in the prisms 92. However, the brightness enhancement film 1 of the present invention can provide a predetermined amount of the light scattering particles 122 to further change in curvature on the meandering surfaces 12a and 12b of the curved prism units 12. Accordingly, the light scattering particles 122 can further blare the anti-wet-out effect and the Newton's rings of the brightness enhancement film 1.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A brightness enhancement film, said brightness enhancement film being arranged to be used in a liquid crystal display, comprising:
a substrate including a first surface and a second surface substantially parallel to said first surface, and vertically transmitting light between the first surface and the second surface;
a plurality of curved prism units juxtaposed on the first surface of the substrate, each of the curved prism units having a longitudinal direction and including a ridge, a trough line, and at least one meandering surface located between said ridge and trough line, said ridge and said meandering surface extending and meandering with respect to the longitudinal direction to provide changes in curvature that are able to refract light in two dimensions, wherein directions of said ridge and said meandering surface relative to said longitudinal direction vary along a length of each of the prism units; and
a light-diffusing microstructure layer formed on the second surface of the substrate, said light-diffusing microstructure layer including microstructure protrusions varying in heights with respect to the second surface of the substrate.

2. The brightness enhancement film as defined in claim 1, wherein the microstructure protrusions are randomly formed on the light-diffusing microstructure layer.

3. The brightness enhancement film as defined in claim 1, wherein the light-diffusing microstructure layer includes at least two sets of the microstructure protrusions; wherein one set of the microstructure protrusions is a major repeatedly microstructure unit while the other set is a normal repeatedly microstructure unit and wherein the microstructure protrusions of the major repeatedly microstructure unit have a greater size and a higher height than of those of the normal repeatedly microstructure unit.

4. The brightness enhancement film as defined in claim 1, wherein the microstructure protrusion is in a range of sizes from 0.2 μm to 100 μm.

5. The brightness enhancement film as defined in claim 1, wherein the microstructure protrusion is in the form of spherical cambered protrusion, oval shaped protrusion, olive shaped protrusion, ovum shaped protrusion, cross shaped protrusion, raster shaped protrusion, prism shaped protrusion, curved prism shaped protrusion and irregular faceted protrusion.

6. The brightness enhancement film as defined in claim 5, wherein the prism shaped protrusions or the curved prism shaped protrusions extend in length of the curved prism units.

7. The brightness enhancement film as defined in claim 5, wherein the spherical cambered protrusion, the oval shaped protrusion, the olive shaped protrusion, the ovum shaped protrusion, the cross shaped protrusion, the raster shaped protrusion or the irregular faceted protrusion is formed by a press roller.

8. The brightness enhancement film as defined in claim 1, wherein the light-diffusing microstructure layer is made from a transparent material having the same contractibility with that of the substrate.

9. The brightness enhancement film as defined in claim 1, wherein the brightness enhancement film includes a plurality of light scattering particles embedded in the curved prism units.

10. The brightness enhancement film as defined in claim 9, wherein a predetermined amount of the light scattering particles occupy in the range of weight percentage from 1 to 35 within a total material of 100 weight percentage of the curved prism units.

11. The brightness enhancement film as defined in claim 9, wherein the light scattering particles are made from plastic or glass.

12. The brightness enhancement film as defined in claim 9, wherein the light scattering particles are made from a material selected from the group consisting of SiO₂, Al₂O₃, B₂O₃, CaO, MgO, silicon resin, polyester resin, styrene resin and mixtures thereof.

13. The brightness enhancement film as defined in claim 9, wherein the light scattering particles are in a range of sizes from 0.5 μm to 30 μm.

14. The brightness enhancement film as defined in claim 9, wherein the light scattering particle is in the form of sphere, roughly shaped sphere, olive, ovum or irregular faceted particle.

15. The brightness enhancement film as defined in claim 1, wherein the curved prism unit includes a plurality of lateral ridges arranged on the meandering surface.

16. The brightness enhancement film as defined in claim 1, wherein the curved prism unit includes a first meandering surface and a second meandering surface.

17. The brightness enhancement film as defined in claim 16, wherein each of the first meandering surface and the second meandering surface includes a plurality of lateral ridges; and wherein the lateral ridges of the first meandering surface and the lateral ridges of the second meandering surface are arranged in staggered manner in a longitudinal direction to provide changes in curvature.

18. The brightness enhancement film as defined in claim 16, wherein an included angle formed between the first meandering surface and the second meandering surface located at the ridge of the curved prism unit is in the range of 70 degrees to 160 degrees.

19. The brightness enhancement film as defined in claim 1, wherein each meandering surface of the curved prism units provides regular changes in curvature.

20. The brightness enhancement film as defined in claim 1, wherein each meandering surface of the curved prism units provides free of regular changes in curvature.

21. The brightness enhancement film as defined in claim 1, wherein each of the curved prism units has a vertical height with respect to the first surface of the substrate; and wherein the vertical heights of the curved prism units are all the same.

22. The brightness enhancement film as defined in claim 1, wherein each of the curved prism units has a vertical height with respect to the first surface of the substrate; and wherein the vertical height of the curved prism unit is in the range of 10 μm to 100 μm.

23. The brightness enhancement film as defined in claim 1, wherein each of the curved prism units has a horizontal width with respect to the first surface of the substrate; and wherein the horizontal width of the curved prism unit is in the range of 10 μm to 250 μm.

24. The brightness enhancement film as defined in claim 1, wherein the substrate is made from a material selected from the group consisting of polyethylene-terephthalate (PET), polyethylene (PE), polyethylene napthalate (PEN), polycarbonate (PC), polyvinyl alcohol (PVA), polyvinyl chloride (PVC), macromolecule and mixtures thereof.
